(19) United States
(12) Patent Application Publication
(10) Pub. No.: US 2024/0297295 A1
(43) Pub. Date: Sep. 5, 2024

(54) BATTERY CATHODES

(71) Applicant: Conamix Inc., Ithaca, NY (US)

(72) Inventor: Stephen Burkhardt, Ithaca, NY (US)

(21) Appl. No.: 18/572,823

(22) PCT Filed: Jun. 29, 2022
(86) PCT No.: PCT/US22/35424

§ 371 Date: Dec. 21, 2023

Related U.S. Application Data
(60) Provisional application No. 63/217,169, filed on Jun. 30, 2021.

(51) Int. Cl. H01M 4/36; H01M 4/02; H01M 4/133; H01M 4/136; H01M 4/58; H01M 4/587; H01M 10/0525

(52) U.S. Cl. CPC H01M 4/366; H01M 4/133; H01M 4/136; H01M 4/5815; H01M 4/587; H01M 10/0525; H01M 2004/021; H01M 2004/028

(57) ABSTRACT

This application relates to lithium batteries with a novel cathode comprising a current collector, at least one first active material layer comprising a conversion active material, and at least one second active material layer comprising a lithium ion intercalation active material.

### CROSS-REFERENCE TO RELATED APPLICATIONS

This application claims the benefit of U.S. Provisional Patent Application No. 63/217,169, filed on Jun. 30, 2021, the disclosure of which is hereby incorporated by reference herein in its entirety.

### TECHNICAL FIELD

This application relates to cathodes for use in secondary batteries or other energy storage devices, and methods of making the same.

### BACKGROUND

A major objective in the commercial development of next generation rechargeable batteries is to provide batteries with higher energy densities and lower cost than state of the art lithium ion batteries. One of the most promising approaches to this goal is the use of a sulfur cathode coupled with a lithium metal anode. Sulfur is inexpensive, abundant, and offers a theoretical energy capacity that is an order of magnitude higher than conventional metal oxide-based intercalation cathodes used in current lithium ion cells. Similarly, anodes based on metallic lithium have a substantially higher energy density than lithium graphite anodes used in current lithium ion cells. However, manufacture of a practical lithium-sulfur battery has been an elusive goal. Among the numerous challenges that plague sulfur cathodes, one of the more serious is redistribution of sulfur within the battery during operation—there is the well known phenomenon of polysulfide shuttle whereby soluble polysulfides migrate to and from the anode as well inopportune precipitation of insoluble species such as sulfur, Li₂S and Li₂S₂ in places where it becomes electrochemically inaccessible or otherwise problematic.

There remains a need to address these issues to enable manufacture of practical sulfur batteries that exhibit high gravimetric energy density and which are simultaneously able to deliver discharge rates and cycle life capacities sufficient to serve critical applications such as electric vehicles. The present disclosure addresses these and related challenges.

### SUMMARY

Among other things, the present disclosure provides cathodes for lithium batteries comprising at least two active material layers where at least one layer comprises a conversion active material and at least one layer comprises a lithium ion intercalation active material. In some embodiments, provided cathodes are for lithium-sulfur batteries and comprise a current collector, at least one first active material layer comprising conversion active material, and at least one second active material layer comprising lithium ion intercalation active material, wherein the second active material layer is situated between the current collector and the first active material layer. In some embodiments, provided cathodes are characterized in that an intercalation/de-intercalation potential (or discharge voltage) of the lithium ion intercalation active material overlaps with that of the conversion active material. In some embodiments, the conversion active material comprises electroactive sulfur. In certain embodiments, lithium-sulfur batteries employing a provided cathode have improved performance (e.g., cycle life, energy density or active material utilization).

The present disclosure is also directed to methods of making and/or improving performance of a lithium-sulfur battery comprising a current collector, at least one first active material layer comprising conversion active material, and at least one second active material layer comprising lithium ion intercalation active material, wherein the second active material layer is situated between the current collector and the first active material layer.

### DEFINITIONS

For the present disclosure to be more readily understood, certain terms are first defined below. Additional definitions for the following terms and other terms are set forth throughout the specification.

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Electroactive Sulfur: As used herein, the term “electroactive sulfur” refers to a sulfur-containing composition comprising one or more sulfur atoms capable of changing its oxidation state in a charge-transfer step of an electrochemical reaction.

Polymer: As used herein, the term “polymer” generally refers to a substance that has a molecular structure consisting chiefly or entirely of repeated sub-units bonded together, such as synthetic organic materials used as plastics and resins.

Substantially: As used herein, the term “substantially” refers to the qualitative condition of exhibiting total or near-total extent or degree of a characteristic or property of interest.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosed compositions and methods and are not intended as limiting. For purposes of clarity, not every component may be labeled in every drawing. In the following description, various embodiments are described with reference to the following drawings, in which:

FIG. 1 is a pictorial representation of a cross section of an electrochemical cell according to one or more embodiments of the disclosure;

FIG. 2 is a pictorial representation of a cross section of an electrochemical cell according to one or more embodiments of the disclosure;

FIG. 3 is a pictorial representation of a cylindrical battery embodying concepts of the disclosure; and

FIG. 4 is a pictorial representation of a coin cell assembly according to one or more embodiments of the disclosure.

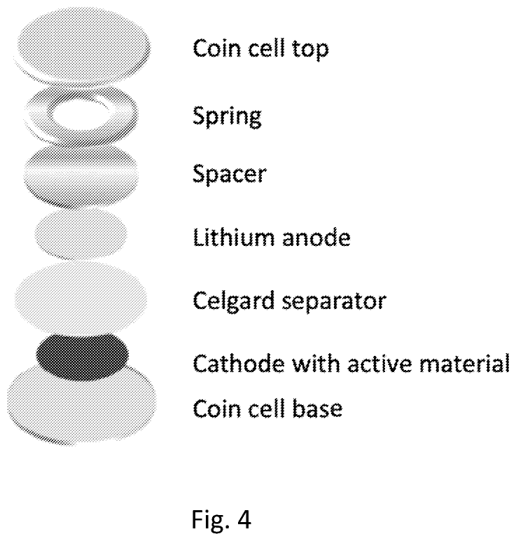

### DETAILED DESCRIPTION OF THE INVENTION

In some embodiments, the present disclosure is directed to novel cathodes for use in lithium-sulfur batteries and related methods for fabricating and using such devices. In some embodiments, the present disclosure provides such lithium-sulfur batteries, wherein a cathode comprises active material layers of at least one conversion active material and at least one lithium ion intercalation active material. Such active materials layers lead to improved electrochemical cycling properties at higher current densities and improved cycle life.

The present disclosure encompasses the recognition that the accumulation of undesirable sulfur precipitates in the cathode of lithium-sulfur batteries can result in “cathode shutdown”, i.e., an increase in cell resistance, a drop in cell voltage and/or a limit to the rate capability of the cell. Such precipitates may occur, for example, within the pore structure of a cathode and/or at the cathode surface. While not wishing to be bound by any particular theory, Applicant proposes the possibility that cathode shutdown occurs because of a high concentration of sulfides at a cathode/separator interface. Such high concentrations of sulfides can be due to, for example, migration of soluble sulfides towards the cathode, and/or polysulfides that are rapidly oxidized at a cathode/separator interface upon return from an anode side of a cell during shuttling on charge. The present invention therefore provides, in some embodiments, the identification of the previously unknown source of a problem.

In a lithium-battery cell, sulfides move due to both migration and diffusion. Migration can occur because a field is created whereby a high concentration of lithium ions at an anode and a high concentration of sulfides are created at a cathode simultaneously. Diffusion can occur because a high concentration of soluble sulfides is generated at a cathode, creating a concentration gradient. The present disclosure encompasses the recognition that it may be desirable to have a uniform concentration of polysulfides in a cathode host for more optimal kinetics and cycle life.

Cathodes provided by the present disclosure facilitate conditions under which sulfides can migrate back towards a cathode current collector due to a high concentration of cations close to the cathode current collector. This may be achieved, in some embodiments, by coating a current collector with a lithium ion intercalation compound (e.g., a lithium ion intercalation active material). While not wishing to be bound by any particular theory, a lithium ion intercalation active material, upon charging of the cell, can de-intercalate and expel lithium ions into a cathode, resulting in a local concentration of cations and subsequent migration of anions (e.g., sulfides) back towards a current collector. Applicant proposes that with additional charging, sulfides may be re-oxidized to sulfur and a lithium concentration in a cell may re-equilibrate. As described by the present disclosure, providing a source of additional lithium cations at the cathode balances the lithium concentration and thus counteracts the development of concentration gradients of anions within the battery cell. This novel approach is thus designed to retain polysulfides within the cathode and avoid or minimize the accumulation of uncontrolled sulfur precipitates at the cathode surface that can result in shutdown.

In certain embodiments, a suitable lithium ion active material will exhibit an intercalation/de-intercalation potential (or discharge voltage) that overlaps with the discharge voltage range of the conversion active material. For example, in the case where sulfur is the conversion material, the voltage window of the intercalation/de-intercalation material overlaps with the potential at which sulfur-lithium sulfide interconversion occurs. In some embodiments, a mixture of lithium intercalation compounds may be useful to maximize an overlap of intercalation potential(s) (or discharge voltage(s)) of a mixture of lithium ion intercalation compounds with that of a conversion active material.

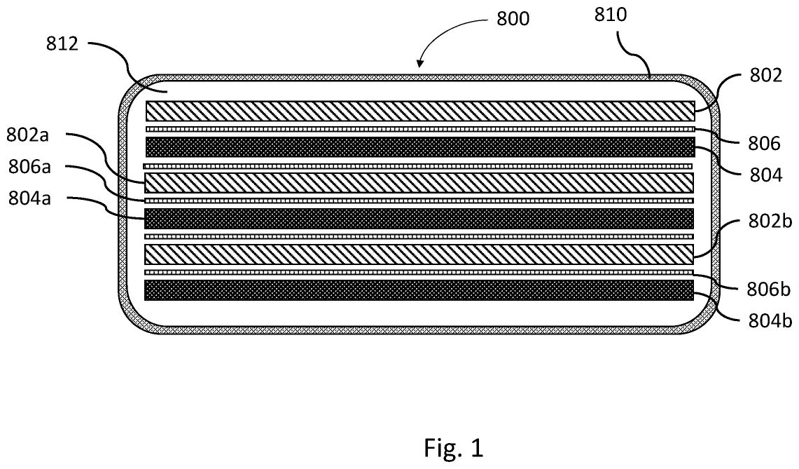

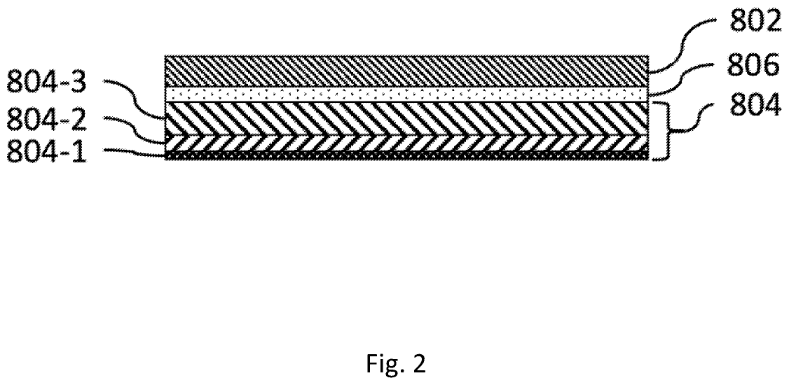

FIG. 1 illustrates a cross section of an electrochemical cell 800 in accordance with exemplary embodiments of the disclosure. Electrochemical cell 800 includes a negative electrode 802, a positive electrode 804, a separator 806 interposed between negative electrode 802 and positive electrode 804, a container 810, and a fluid electrolyte 812 in contact with negative and positive electrodes 802, and 804 respectively. Such cells optionally include additional layers of electrode and separators 802a, 802b, 804a, 804b, 806a, and 806b. FIG. 2 illustrates another view of a cross section through a representative cell stack showing the negative electrode 802, a positive electrode 804, and a separator 806 interposed between the negative electrode 802 and positive electrode 804. FIG. 2 also shows the layers comprising the electrode 804. Specifically, the layers include current collector 804-1, cathode layer 804-2 comprising a lithium intercalation active material and cathode layer 804-3 comprising a conversion active material. As shown, the lithium intercalation active material 804-2 is interposed between current collector 804-1 and cathode layer 804-3.

Negative electrode 802 (also sometimes referred to herein as an anode) comprises a negative electrode active material that can accept cations. Non-limiting examples of negative electrode active materials for lithium-based electrochemical cells include Li metal, Li alloys such as those of Si, Sn, Bi, In, and/or Al alloys, Li₄Ti₅O₁₂, hard carbon, graphitic carbon, metal chalcogenides, and/or amorphous carbon. In accordance with some embodiments of the disclosure, most (e.g., greater than 90 wt %) of an anode active material can be initially included in a discharged positive electrode 804 (also sometimes referred to herein as a cathode) when electrochemical cell 800 is initially made, so that an electrode active material forms part of first electrode 802 during a first charge of electrochemical cell 800.

A technique for depositing electroactive material on a portion of negative electrode 802 is described in U.S. Patent Publication No. 2016/0172660 and similarly in U.S. Patent Publication No. 2016/0172661, the contents of each of which are hereby incorporated herein by reference, to the extent such contents do not conflict with the present disclosure.

Negative electrode 802 and positive electrode 804 can further include one or more electronically conductive additives as described herein. In accordance with some embodiments of the disclosure, negative electrode 802 and/or positive electrode 804 further include one or more polymer binders as described below.

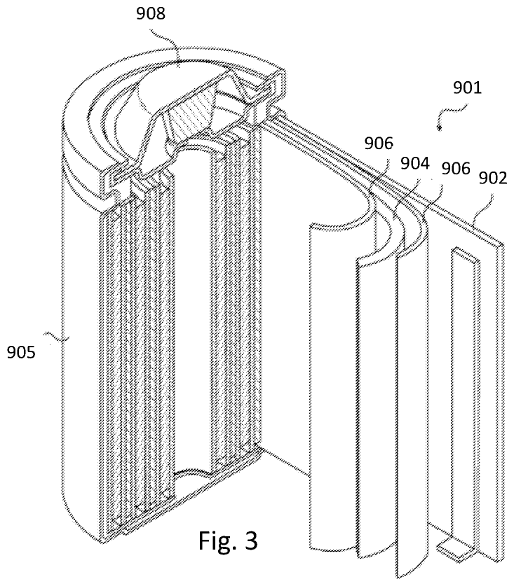

FIG. 3 illustrates an example of a battery according to various embodiments described below. A cylindrical battery is shown here for illustration purposes, but other types of arrangements, including prismatic or pouch (laminate-type) batteries, may also be used as desired. Example Li battery 901 includes a negative anode 902, a positive cathode 904, a separator 906 interposed between the anode 902 and the cathode 904, an electrolyte (not shown) impregnating the separator 906, a battery case 905, and a sealing member 908 sealing the battery case 905. It will be appreciated that example battery 901 may simultaneously embody multiple aspects of the present disclosure in various designs.

In some embodiments, a lithium-sulfur battery of the present disclosure comprises a lithium anode, a sulfur-based cathode, and an electrolyte permitting ion transport between anode and cathode. In certain embodiments, described herein, an anodic portion of a battery comprises an anode and a portion of electrolyte with which it is in contact. Similarly, in certain embodiments, described herein, a cathodic portion of a battery comprises a cathode and a portion of electrolyte with which it is in contact. In certain embodiments, a battery comprises a lithium ion-permeable separator, which defines a boundary between an anodic portion and a cathodic portion. In certain embodiments, a battery comprises a case, which encloses both anodic and cathodic portions. In certain embodiments, a battery case comprises an electrically conductive anodic-end cover in electrical communication with an anode, and an electrically conductive cathodic-end cover in electrical communication with a cathode to facilitate charging and discharging via an external circuit.

### A. CATHODE

A cathode as described herein has a multilayer structure and comprises at least one first active material layer and at least one second active material layer. In certain embodiments, a first active material layer comprises a conversion active material. In certain embodiments, a second active material layer comprises a lithium ion intercalation active material. In some embodiments, a provided cathode comprises at least one of a first active material layer comprising a conversion active material and at least one of a second active material layer comprising a lithium ion intercalation active material.

In certain embodiments, a provided cathode comprises a current collector. In some embodiments, a provided cathode comprises a current collector, at least one first active material layer comprising a conversion active material, and at least one second active material layer comprising a lithium ion intercalation active material. In certain embodiments, a second active material layer comprising a lithium ion intercalation active material is disposed between a current collector and a first active material layer comprising a conversion active material.

In certain embodiments, a current collector comprises a component selected from a metal foil, a metallized polymer film, and a carbon composition. In some embodiments, a current collector comprises aluminum foil, copper foil, nickel foil, stainless steel foil, titanium foil, zirconium foil, molybdenum foil, nickel foam, copper foam, carbon paper or fiber sheets, polymer substrates coated with conductive metal, and/or combinations thereof. In certain embodiments, a current collector comprises a metal foil. In certain embodiments, a current collector comprises a metallized polymer film. In certain embodiments, a current collector comprises a carbon composition. In certain embodiments, a cathode comprises a conductive carbon coating between a current collector and a second active layer comprising a lithium ion intercalation active material.

In certain embodiments, both a first active material layer comprising a conversion active material and a second active material layer comprising a lithium ion intercalation active material are both porous. In certain embodiments, a first active material layer comprising a conversion active material is porous. In certain embodiments, a second active material layer comprising a lithium ion intercalation active material is porous. In certain embodiments, a second active material layer comprising a lithium ion intercalation active material exhibits a lower porosity than a first active material layer comprising a conversion active material. In certain embodiments, a second active material layer comprising a lithium ion intercalation active material exhibits the same porosity as a first active material layer comprising a conversion active material. In certain embodiments, a second active material layer comprising a lithium ion intercalation active material exhibits a higher porosity than a first active material layer comprising a conversion active material.

In certain embodiments, a first active material layer comprising a conversion active material comprises a porosity gradient. In certain embodiments, a first active layer comprising a conversion active material comprises a lower porosity towards an interface of a first active material layer comprising a conversion active material with a second active material layer comprising a lithium ion intercalation active material.

In certain embodiments, a discharge voltage range of a conversion active material and a discharge voltage range of a lithium ion intercalation active material substantially overlap. In certain embodiments, a discharge voltage range of a lithium ion intercalation active material is higher than a discharge voltage range of a conversion active material. In certain embodiments, a discharge voltage range of a lithium ion intercalation active material is equal to a discharge voltage range of a conversion active material. In certain embodiments, a discharge voltage range of a lithium ion intercalation active material is lower than a discharge voltage range of a conversion active material.

In certain embodiments, a lithium ion intercalation active material comprises a discharge voltage (or potential) range of about 1 to about 3 volts. In certain embodiments, a lithium ion intercalation active material comprises a discharge voltage range of about 1.5 to about 2.8 volts. In certain embodiments, a lithium ion intercalation active material comprises a discharge voltage range of about 1.8 to about 2.8 volts. In certain embodiments, a lithium ion intercalation active material comprises a discharge voltage range of about 2 to about 2.5 volts. In certain embodiments, a lithium ion intercalation active material comprises a discharge voltage range of about 2 to about 2.2 volts. In certain embodiments, a lithium ion intercalation active material comprises a discharge voltage of about 2, 2.1, or 2.2 volts.

In certain embodiments, a conversion active material comprises a discharge voltage (or potential) range of about 1 to about 3 volts. In certain embodiments, a conversion active material comprises a discharge voltage range of about 1.5 to about 2.8 volts. In certain embodiments, a conversion active material comprises a discharge voltage range of about 1.8 to about 2.8 volts. In certain embodiments, a conversion active material comprises a discharge voltage range of about 2 to about 2.5 volts. In certain embodiments, a conversion active material comprises a discharge voltage range of about 2 to about 2.2 volts. In certain embodiments, a conversion active material comprises a discharge voltage of about 2, 2.1, and 2.2 volts.

In certain embodiments, a conversion active material comprises a total theoretical discharge capacity of about 2 to about 5 times greater than a discharge capacity of a lithium ion intercalation material. In certain embodiments, a conversion active material comprises a total theoretical discharge capacity of about 2 to about 4 times greater than a discharge capacity of a lithium ion intercalation active material. In certain embodiments, a conversion active material comprises a total theoretical discharge capacity of about 3 to about 4 times greater than a discharge capacity of a lithium ion intercalation active material. In certain embodiments, a conversion active material comprises a total theoretical discharge capacity of about 2, 3, 4, and 5 times greater than a discharge capacity of a lithium ion intercalation active material.

In certain embodiments, a lithium ion intercalation active material comprises one or more components selected from the group consisting of metal oxides, metal sulfides, metal phosphates, metal selenides, mixtures, and/or combination thereof. In certain embodiments, a lithium ion intercalation active material comprises one or more metal sulfides. In certain embodiments, a lithium ion intercalation active material comprises a metal sulfide. In certain embodiments, a metal sulfide is selected from the group consisting of vanadium sulfide (e.g., VS₂), molybdenum sulfide (e.g., MoS₂ and/or Mo₆S₈), and titanium sulfide (e.g., TiS₂). In certain embodiments, a metal sulfide is selected from the group consisting of VS₂, MoS₂, Mo₆S₈, and TiS₂. In certain embodiments, a metal sulfide is TiS₂. In certain embodiments, a metal sulfide is Mo₆S₈.

In certain embodiments, a provided cathode comprises three or more active material layers, wherein each active material layer is selected from a conversion active material and a lithium ion intercalation active material. In certain embodiments, a provided cathode comprises between 3 and 12 active material layers. In certain embodiments, a provided cathode comprises between 4 and 12 active material layers. In certain embodiments, a provided cathode comprises between 4 and 8 active material layers. In certain embodiments, a provided cathode comprises between 4 and 6 active material layers. In certain embodiments, a provided cathode comprises between 3 and 6 active material layers. In certain embodiments, a provided cathode comprises between 6 and 12 active material layers. In certain embodiments, a provided cathode comprises 3, 4, 5, 6, 7, 8, 9, 10, 11, or 12 active material layers. In certain embodiments, a provided cathode comprises alternating layers of a conversion active material and a lithium ion intercalation active material. In certain embodiments, an active material layer closest to a current collector comprises a lithium intercalation active material. In certain embodiments, a lithium ion intercalation active material may serve as a current collector, for example a 3-layered cathode with a lithium ion intercalation active material situated in between two layers of conversion active material and wherein a cathode tab is welded along the side of the cathode.

In certain embodiments, a lithium-sulfur battery comprises a sulfur-based cathode. In certain embodiments, a cathode of a lithium-sulfur battery comprises a positive active material and a conductive material. In certain embodiments, a cathode of a lithium-sulfur battery comprises a positive active material, a conductive material, and a binder. In certain embodiments, a positive active material is electroactive sulfur. In certain embodiments, electroactive sulfur is selected from the group consisting of elemental sulfur (S₈), a sulfur-based compound, a sulfur-containing polymer, or combinations thereof. In certain embodiments, a sulfur-based compound is selected from the group consisting of Li₂Sₙ (n≥1), organic-sulfur compounds, and carbon-sulfur polymers ((C₂Sₓ)ₙ where x=2.5 to 50 and n≥2). In certain embodiments, electroactive sulfur in a lithium-sulfur battery comprises elemental sulfur. In certain embodiments, electroactive sulfur in a lithium-sulfur battery comprises a sulfur-containing polymer.

In certain embodiments, a conductive material comprises an electrically conductive material that facilitates movement of electrons within a cathode. For example, in certain embodiments, a conductive material is selected from the group consisting of carbon-based materials, graphite-based materials, conductive polymers, and combinations thereof. In certain embodiments, a conductive material comprises a carbon-based material. In certain embodiments, a conductive material comprises a graphite-based material. For example, in certain embodiments, an electrically conductive material is selected from the group consisting of conductive carbon powders, such as carbon black, Super P®, C-NERGY™ Super C65, Ensaco® black, Ketjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, graphene, graphene oxide, carbon nanotubes, fullerenes, hard carbon, mesocarbon microbeads, and the like. In certain embodiments, a conductive material comprises one or more conductive polymers. For example, in certain embodiments, a conductive polymer is selected from the group consisting of polyaniline, polythiophene, polyacetylene, polypyrrole, and the like. In certain embodiments, a conductive material is used alone. In other embodiments, a conductive material is used as a mixture of two or more conductive materials described above.

In certain embodiments, a binder is adhered to a positive active material on a current collector. Typical binders include polyvinylidene fluoride, poly(vinylidene fluoride-co-hexafluoropropene) (PVDF/HFP), Polytetrafluoroethylene (PTFE), Kynar Flex® 2801, Kynar® Powerflex LBG, Kynar® HSV 900, Teflon®, carboxymethylcellulose, styrene-butadiene rubber (SBR), polyethylene oxide, polypropylene oxide, polyethylene, polypropylene, polyacrylates, polyvinyl pyrrolidone, poly(methyl methacrylate), polyethyl acrylate, polytetrafluoroethylene, polyvinyl chloride, polyacrylonitrile, polycaprolactam, polyethylene terephthalate, polybutadiene, polyisoprene or polyacrylic acid, or derivatives, mixtures, or copolymers of any of these. In some embodiments, a binder is water soluble binder, such as sodium alginate or carboxymethyl cellulose. Generally, binders hold the active materials together and in contact with a current collector (e.g., aluminum foil or copper foil). In certain embodiments, a binder is selected from the group consisting of poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, a copolymer of polyhexafluoropropylene and polyvinylidene fluoride, polyethyl acrylate, polytetrafluoroethylene, polyvinyl chloride, polyacrylonitrile, polyvinyl pyridine, polystyrene, and derivatives, mixtures, and copolymers thereof.

In certain embodiments, a cathode further comprises a coating layer. For example, in certain embodiments, a coating layer comprises a polymer, an inorganic material, or a mixture thereof. In certain such embodiments, a polymer is selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride-co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, a sulfonated styrene/ethylene-butylene/styrene triblock copolymer, polyethylene oxide, and derivatives, mixtures, and copolymers thereof. In certain such embodiments, an inorganic material comprises, for example, colloidal silica, amorphous silica, surface-treated silica, colloidal alumina, amorphous alumina, tin oxide, titanium oxide, titanium sulfide (TiS₂), vanadium oxide, zirconium oxide (ZrO₂), iron oxide, iron sulfide (FeS), iron titanate (FeTiO₃), barium titanate (BaTiO₃), and combinations thereof. In certain embodiments, an organic material comprises conductive carbon. In certain embodiments, an organic material comprises graphene, graphene oxide.

In certain embodiments, provided mixtures can be formulated without a binder, which can be added during manufacture of electrodes (e.g. dissolved in a solvent used to form a slurry from a provided mixture). In embodiments where binders are included in a provided mixture, a binder can be activated when made into a slurry to manufacture electrodes.

Suitable materials for use in cathode mixtures include those disclosed in Cathode Materials for Lithium Sulfur Batteries: Design, Synthesis, and Electrochemical Performance, Lianfeng, et al., Interchopen.com, published Jun. 1st 2016, and The Strategies of Advanced Cathode Composites for Lithium-Sulfur Batteries, Zhou et al., SCIENCE CHINA Technological Sciences, Volume 60, Issue 2: 175-185(2017), the entire disclosures of each of which are hereby incorporated by reference herein.

### B. ANODE

In certain embodiments, a lithium battery (e.g., a lithium-sulfur battery) comprises a lithium anode. Any lithium anode suitable for use in lithium-sulfur cells may be used. In certain embodiments, an anode of a lithium-sulfur battery comprises a negative active material selected from materials in which lithium intercalation reversibly occurs, materials that react with lithium ions to form a lithium-containing compound, metallic lithium, lithium alloys, and combinations thereof. In certain embodiments, an anode comprises metallic lithium. In certain embodiments, lithium-containing anodic compositions comprise carbon-based compounds. In certain embodiments, a carbon-based compound is selected from the group consisting of crystalline carbon, amorphous carbon, graphite, and mixtures thereof. In certain embodiments, a material that reacts with lithium ions to form a lithium-containing compound is selected from the group consisting of tin oxide (SnO₂), titanium nitrate, and silicon. In certain embodiments, a lithium alloy comprises an alloy of lithium with another alkali metal (e.g. sodium, potassium, rubidium or cesium). In certain embodiments, a lithium alloy comprises an alloy of lithium with a transition metal. In certain embodiments, lithium alloys include alloys of lithium and a metal selected from the group consisting of Na, K, Rb, Cs, Fr, Be, Mg, Ca, Sr, Ba, Ra, Al, Sn, and combinations thereof. In certain embodiments, a lithium alloy comprises an alloy of lithium with indium. In certain embodiments, an anode comprises a lithium-silicon alloy. Examples of suitable lithium-silicon alloys include: Li₁₅Si₄, Li₁₂Si₇, Li₇Si₃, Li₁₃Si₄, and Li₂₁Si₅/Li₂₂Si₅. In certain embodiments, a lithium metal or lithium alloy is present as a composite with another material. In certain embodiments, such composites include materials such as graphite, graphene, metal sulfides or oxides, or conductive polymers.

An anode may be protected against redox shuttling reactions and hazardous runaway reactions by any of the methodologies reported in the art, for example, by creating a protective layer on a surface of an anode by chemical passivation or polymerization. For example, in certain embodiments, an anode comprises an inorganic protective layer, an organic protective layer, or a mixture thereof, on a surface of lithium metal. In certain embodiments, an inorganic protective layer comprises Mg, Al, B, Sn, Pb, Cd, Si, In, Ga, lithium silicate, lithium borate, lithium phosphate, lithium phosphoronitride, lithium silicosulfide, lithium borosulfide, lithium aluminosulfide, lithium phosphosulfide, lithium fluoride or combinations thereof. In certain embodiments, an organic protective layer includes a conductive monomer, oligomer, or polymer selected from poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-di-yl), or combinations thereof.

Moreover, in certain embodiments, inactive sulfur material, generated from an electroactive sulfur material of a cathode, during charging and discharging of a lithium-sulfur battery, attaches to an anode surface. The term “inactive sulfur”, as used herein, refers to sulfur that has no activity upon repeated electrochemical and chemical reactions, such that it cannot participate in an electrochemical reaction of a cathode. In certain embodiments, inactive sulfur on an anode surface acts as a protective layer on such electrode. In certain embodiments, inactive sulfur is lithium sulfide.

It is further contemplated that the present disclosure can be adapted for use in sodium-sulfur batteries. Such sodium-sulfur batteries comprise a sodium-based anode, and are encompassed within the scope of present disclosure.

### C. PREPARATION OF ELECTRODES

There are a variety of methods for manufacturing electrodes for use in a lithium battery (e.g., a lithium-sulfur battery). One process, such as a “wet process,” involves adding a positive active material, a binder and a conducting material (i.e., a cathode mixture) to a liquid to prepare a slurry composition. These slurries are typically in the form of a viscous liquid that is formulated to facilitate a downstream coating operation. A thorough mixing of a slurry can be important for coating and drying operations, which affect performance and quality of an electrode. Suitable mixing devices include ball mills, magnetic stirrers, sonication, planetary mixers, high speed mixers, homogenizers, universal type mixers, and static mixers. A liquid used to make a slurry can be one that homogeneously disperses a positive active material, a binder, a conducting material, and any additives, and that is easily evaporated. Suitable slurry liquids include, for example, N-methylpyrrolidone, acetonitrile, methanol, ethanol, propanol, butanol, tetrahydrofuran, water, isopropyl alcohol, dimethylpyrrolidone, and the like.

In some embodiments, a prepared composition is coated on a current collector and dried to form an electrode. Specifically, a slurry is used to coat an electrical conductor to form an electrode by evenly spreading a slurry on to a conductor, which is then, in certain embodiments, roll-pressed (e.g. calendared) and heated as is known in the art. Generally, a matrix of a positive active material and conductive material are held together and on a conductor by a binder. In certain embodiments, a matrix comprises a lithium conducting polymer binder, such as polyvinylidene fluoride (PVDF), poly(vinylidene fluoride-co-hexafluoropropene) (PVDF/HFP), Polytetrafluoroethylene (PTFE), Kynar Flex® 2801, Kynar® Powerflex LBG, Kynar® HSV 900, Teflon®, styrene butadiene rubber (SBR), polyethylene oxide (PEO), or polytetrafluoroethylene (PTFE). In certain embodiments, additional carbon particles, carbon nanofibers, carbon nanotubes, are dispersed in a matrix to improve electrical conductivity. Alternatively or additionally, in certain embodiments, lithium ions are dispersed in a matrix to improve lithium conductivity.

In certain embodiments, a current collector is selected from the group consisting of: aluminum foil, copper foil, nickel foil, stainless steel foil, titanium foil, zirconium foil, molybdenum foil, nickel foam, copper foam, carbon paper or fiber sheets, polymer substrates coated with conductive metal, and/or combinations thereof.

PCT Publication Nos. WO2015/003184, WO2014/074150, and WO2013/040067, the entire disclosures of which are hereby incorporated by reference herein, describe various methods of fabricating electrodes and electrochemical cells.

### D. SEPARATOR

In certain embodiments, a lithium-sulfur battery comprises a separator, which divides an anode and cathode. In certain embodiments, a separator is an impermeable material substantially, or completely, impermeable to electrolyte. In certain embodiments, a separator is impermeable to polysulfide ions dissolved in electrolyte. In certain embodiments, a separator as a whole is impermeable to electrolyte, such that passage of electrolyte-soluble sulfides is blocked. In some embodiments, a degree of ionic conductivity across a separator is provided, for example via apertures in such separator. In certain such embodiments, a separator as a whole inhibits or restricts passage of electrolyte-soluble sulfides between anodic and cathodic portions of a battery as a result of its impermeability. In certain embodiments, a separator of impermeable material is configured to allow lithium ion transport between anode and cathode of a battery during charging and discharging of a cell. In some such embodiments, a separator does not completely isolate an anode and a cathode from each other. One or more electrolyte-permeable channels bypassing, or penetrating through apertures in, an impermeable face of a separator must be provided to allow sufficient lithium ion flux between anodic and cathodic portions of a battery. In some embodiments, where a separator is itself completely impermeable, a channel is provided through an annulus between a periphery of a separator and walls of a battery case.

It will be appreciated by a person skilled in the art that optimal dimensions of a separator must balance competing imperatives: maximum impedance to polysulfide migration while allowing sufficient lithium ion flux. Aside from this consideration, shape and orientation of a separator is not particularly limited, and depends in part on battery configuration. For example, a separator may be substantially circular in a coin-type cell, and substantially rectangular in a pouch-type cell. As described herein, a surface of a separator may be devoid of apertures, so that lithium ion flux occurs exclusively around edges of an impermeable sheet. However, certain embodiments are also contemplated in which some or all of a required lithium ion flux is provided through apertures in a separator. In some embodiments, a separator is substantially flat. However, it is not excluded that curved or other non-planar configurations may be used.

A separator may be of any suitable thickness. In order to maximize energy density of a battery, it is generally preferred that a separator is as thin and light as possible. However, a separator should be thick enough to provide sufficient mechanical robustness and to ensure suitable impermeability. In certain embodiments, a separator has a thickness of from about 1 micron to about 200 microns, preferably from about 5 microns to about 100 microns, more preferably from about 10 microns to about 30 microns.

### E. ELECTROLYTE

In certain embodiments, a lithium-sulfur battery comprises an electrolyte comprising an electrolytic salt. Examples of electrolytic salts include, for example, lithium trifluoromethane sulfonimide, lithium triflate, lithium perchlorate, LiPF₆, LiBF₄, tetraalkylammonium salts (e.g. tetrabutylammonium tetrafluoroborate, TBABF₄), liquid state salts at room temperature (e.g. imidazolium salts, such as 1-ethyl-3-methylimidazolium bis-(perfluoroethyl sulfonyl)imide, EMIBeti), and the like.

In certain embodiments, an electrolyte comprises one or more alkali metal salts. In certain embodiments, such salts comprise lithium salts, such as LiCF₃SO₃, LiClO₄, LiNO₃, LiPF₆, and LiTFSI, or combinations thereof. In certain embodiments, an electrolyte comprises ionic liquids, such as 1-ethyl-3-methylimidzaolium-TFSI, N-butyl-N-methyl-piperidinium-TFSI, N-methyl-n-butyl pyrrolidinium-TFSI, and N-methyl-N-propylpiperidinium-TFSI, or combinations thereof. In certain embodiments, an electrolyte comprises superionic conductors, such as sulfides, oxides, and phosphates, for example, phosphorous pentasulfide, or combinations thereof.

In certain embodiments, an electrolyte is a liquid. For example, in certain embodiments, an electrolyte comprises an organic solvent. In certain embodiments, an electrolyte comprises only one organic solvent. In some embodiments, an electrolyte comprises a mixture of two or more organic solvents. In certain embodiments, a mixture of organic solvents comprises organic solvents from at least two groups selected from weak polar solvent groups, strong polar solvent groups, and lithium protection solvents.

The term “weak polar solvent,” as used herein, is defined as a solvent that is capable of dissolving elemental sulfur and has a dielectric coefficient of less than 15. In some embodiments, a weak polar solvent is selected from aryl compounds, bicyclic ethers, and acyclic carbonate compounds. Non-limiting examples of weak polar solvents include xylene, dimethoxyethane, 2-methyltetrahydrofuran, diethyl carbonate, dimethyl carbonate, toluene, dimethyl ether, diethyl ether, diglyme, tetraglyme, and the like. The term “strong polar solvent,” as used herein, is defined as a solvent that is capable of dissolving lithium polysulfide and has a dielectric coefficient of more than 15. In some embodiments, a strong polar solvent is selected from bicyclic carbonate compounds, sulfoxide compounds, lactone compounds, ketone compounds, ester compounds, sulfate compounds, and sulfite compounds. Non-limiting examples of strong polar solvents include hexamethyl phosphoric triamide, y-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, ethylene glycol sulfite, and the like. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. In some embodiments, a lithium protection solvent is selected from saturated ether compounds, unsaturated ether compounds, and heterocyclic compounds including one or more heteroatoms selected from the group consisting of N, O, and/or S. Non-limiting examples of lithium protection solvents include tetrahydrofuran, 1,3-dioxolane, 3,5-dimethylisoxazole, 2,5-dimethyl furan, furan, 2-methyl furan, 1,4-oxane, 4-methyldioxolane, and the like.

In certain embodiments, an electrolyte is a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte comprises an ethereal solvent.

In certain embodiments, an organic solvent comprises an ether. In certain embodiments, an organic solvent is selected from the group consisting of 1,3-dioxolane, dimethoxyethane, diglyme, triglyme, γ-butyrolactone, γ-valerolactone, and combinations thereof. In certain embodiments, an organic solvent comprises a mixture of 1,3-dioxolane and dimethoxyethane. In certain embodiments, an organic solvent comprises a 1:1 v/v mixture of 1,3-dioxolane and dimethoxyethane. In certain embodiments, an organic solvent is selected from the group consisting of: diglyme, triglyme, γ-butyrolactone, γ-valerolactone, and combinations thereof. In certain embodiments, an electrolyte comprises sulfolane, sulfolene, dimethyl sulfone, or methyl ethyl sulfone. In some embodiments, an electrolyte comprises ethylene carbonate, propylene carbonate, dimethyl carbonate, diethyl carbonate, or methylethyl carbonate.

In certain embodiments, an electrolyte comprises a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte comprises an ethereal solvent. In certain embodiments, an electrolyte comprises a liquid selected from the group consisting of sulfolane, sulfolene, dimethyl sulfone, and methyl ethyl sulfone. In certain embodiments, an electrolyte comprises a liquid selected from the group consisting of ethylene carbonate, propylene carbonate, dimethyl carbonate, diethyl carbonate, and methylethyl carbonate.

In certain embodiments, an electrolyte is a solid. In certain embodiments, a solid electrolyte comprises a polymer. In certain embodiments, a solid electrolyte comprises a glass, a ceramic, an inorganic composite, or combinations thereof. In certain embodiments, a solid electrolyte comprises a polymer composite with a glass, a ceramic, an inorganic composite, or combinations thereof. In certain embodiments, such solid electrolytes comprise one or more liquid components as plasticizers or to form a “gel electrolyte.”

### F. LITHIUM-SULFUR BATTERY

In one aspect, the present invention provides secondary sulfur batteries comprising cathode compositions described above. In certain embodiments, such batteries include a lithium-containing anode composition coupled to the provided cathode composition by a lithium conducting electrolyte. In some embodiments, such batteries also comprise additional components such as separators between the anode and cathode, anodic and cathodic current collectors, terminals by which a cell can be coupled to an external load, and packaging such as a flexible pouch or a rigid metal container. In some embodiments, the present disclosure is directed to a lithium-sulfur battery comprising a sulfur-containing cathode, a lithium-containing anode, and an electrolyte ionically coupling the anode and cathode. It is further contemplated that the present disclosure regarding secondary sulfur batteries can be adapted for use in sodium-sulfur batteries, and such batteries are also considered within the scope of certain embodiments of the present disclosure.

### G. EXAMPLES

The following examples embody certain compositions and methods of the present disclosure and demonstrate the fabrication of lithium-sulfur batteries according to certain embodiments herein. Moreover, the following examples are included to demonstrate the principles of the disclosed compositions and methods and are not intended as limiting.

### Example 1: Construction of a Battery with a Two-Layer Cathode Comprising a TiS₂ Layer and a Carbon-Sulfur Composite Layer

Example 1 describes a cathode according to certain embodiments of the present invention in which a layer of TiS₂ (i.e. a lithium ion intercalation active material) is interposed between an aluminum current collector and a layer of a carbon sulfur composite (i.e. a conversion active material).

Cathode preparation. A slurry was made by combining TiS₂ powder (350 mg), conductive carbon (SuperC65™ 100 mg) and PVDF (50 mg) as a polymer binder with sufficient NMP to provide a castable slurry composition. This slurry was applied at a thickness between 0.2 and 0.4 mm to an aluminum current collector with a doctor blade and dried at 65° C. under vacuum. A second slurry was prepared by mixing a sulfur-carbon composite comprising sulfur melt diffused into a porous carbon host (S:C ratio of 7:3) with polyacrylic acid (partial sodium salt) and conductive carbon (SuperC65™) in a 77:9:14 weight ratio with sufficient ethanol to form a castable slurry. This slurry was applied onto the TiS₂-coated current collector at a thickness of 0.2 to 0.4 mm and the cathode was again dried at 65° C. The resulting cathode had a total thickness of 175-185 micrometers and an areal loading of 4.0-4.5 mg S and 2.4 mg TiS₂/cm².

Coin cell construction. Working in an inert atmosphere glove box, a 12.7 mm diameter punch taken from the prepared dual layer cathode film was placed inside a CR2032 coin cell base and wetted with electrolyte (DME/DOL mixture containing LiTFSI and LiNO₃), a polymer separator (Celgard™) was placed onto the wetted cathode and moistened with additional electrolyte and a 14.3 mm diameter lithium foil disk was placed on top of the separator. The assembly was completed by placing a spacer, spring and lid over the top and crimping the cell closed. Each coin cell contained a total of 26-28 μL of electrolyte providing an E/S ratio of approximately 5:1.

### Comparative Example 2: Construction of a Comparative Battery with a Single Layer Cathode Comprising a Homogenous Mixture of TiS₂ and a Carbon-Sulfur Composite

A slurry was made by combining TiS₂ powder (40 mg), an 80% Sulfur/carbon composite (360 mg), conductive carbon (55 mg) and polyacrylic acid (partial sodium salt) (45 mg) as a polymer binder with an adequate amount of ethanol to form a castable slurry. This slurry was applied to an aluminum current collector with a doctor blade and dried at 65° C. for 12-24 h. The resulting cathode had a total thickness of 110-135 micrometers and an areal loading of 3.1-3.5 mg S and 0.4 mg TiS2/cm2. A coin cell was constructed using a punch from this cathode as describe above in Example 1.

### Example 3: Performance Evaluation of Batteries from Examples 1 to 2

Sets of five cells constructed according to the procedures of Examples 1 and 2 were evaluated using the following galvanostatic cycling protocol: 5.5 formation cycles including a first C/10 discharge, followed by a C/5 charge, a C/10 discharge, a C/5 charge and discharge, two C/3 cycles, a C/5 charge and a C/10 discharge. Following the formation is a loop of nineteen C/3 cycles followed by a C/5 charge and a C/10 discharge, repeated to at least 100 total cycles. 1C is fixed at 4.5mA for the cycling protocol, with each charge pulse to 2.8V and each discharge pulse to 1.8V, with 10 minute rest steps between each galvanostatic pulse.

The average cycle 6 volumetric capacity of coin cells constructed according to Examples 1 and 2 is summarized in Table 1:

| Cathode structure | Average cycle 6 volumetric capacity |
|---|---|
| and % TiS₂ | (mAh/cc (TiS₂ + Sulfur + electrolyte) |
| Bilayer Cathode (22% TiS₂) | 223.1 |
| Homogeneous Mixture (12% TiS₂) | 138.3 |
| Homogeneous Mixture (8% TiS₂) | 199.2 |

The data in Table 1 show that in a homogenous mixture, increasing the TiS₂ content from 8% to 12% leads to a decrease in volumetric capacity (199.2->138.3 mAh/cc). In contrast, with the bilayer structure, an even higher TiS₂ content unexpectedly demonstrates significantly improved volumetric capacity (223.1 mAh/cc).

1. A cathode for a lithium battery, the cathode comprising:
at least one of a first active material layer comprising a conversion active material; and
at least one of a second active material layer comprising a lithium ion intercalation active material.

2. The cathode of claim 1, the cathode comprising:
a current collector;
a first active material layer comprising a conversion active material; and
a second active material layer comprising a lithium ion intercalation active material;
wherein the second active material layer is situated between the current collector and the first active material layer.

3. The cathode of claim 1, wherein the conversion active material comprises an electroactive sulfur composition.

4. The cathode of claim 3, wherein the electroactive sulfur composition is selected from: elemental sulfur, lithium sulfide, lithium polysulfide, polythionate, a sulfur-containing organic molecule, a sulfur-containing polymer, a sulfur-containing carbon composition, and a combination of any two or more of these.

5. The cathode of claim 1, wherein a discharge voltage range of the conversion active material and a discharge voltage range of the lithium ion intercalation active material substantially overlap.

6. The cathode of claim 1, wherein the lithium ion intercalation active material exhibits a higher average discharge voltage than the conversion active material.

7. The cathode of claim 1, wherein the lithium ion intercalation active material exhibits a lower average discharge voltage than the conversion active material.

8. The cathode of claim 1, wherein the conversion active material and the lithium ion intercalation active material both have discharge voltages in the range of 1.8 to 2.8 V.

9. The cathode of claim 1, wherein a total theoretical discharge capacity of the conversion active material is between 2 times and 5 times greater than the discharge capacity of the lithium ion intercalation active material.

10. The cathode of claim 1, wherein the lithium ion intercalation active material is selected from: metal oxides, metal sulfides, metal phosphates, metal selenides, and mixtures of any two or of these.

11. The cathode of claim 1, wherein the lithium ion intercalation active material comprises a metal sulfide.

12. The cathode of claim 11, wherein the metal sulfide is selected from vanadium sulfide, molybdenum sulfide, and titanium sulfide.

13. The cathode of claim 11, wherein the metal sulfide is selected from: VS₂, MoS₂, Mo₆S₈, and TiS₂.

14. The cathode of claim 11, wherein the metal sulfide comprises TiS₂.

15. The cathode of claim 1, wherein both the first and second active material layers are porous.

16. The cathode of claim 1, wherein the second active material layer has a lower porosity than the first active material layer.

17. The cathode of claim 1, wherein there is a porosity gradient in the first active layer, and wherein the first active layer has a lower porosity toward its interface with the second active layer.

18. The cathode of claim 1, further comprising a conductive carbon coating between the current collector and the second active material layer.

19. The cathode of claim 2, wherein the current collector comprises a component selected from the group consisting of a metal foil, a metallized polymer film, and a carbon composition.

20. A cathode for a lithium battery, the cathode comprising three or more active material layers:
the active material layers being of two different types;
a first type comprising a conversion active material; and
a second type comprising a lithium ion intercalation active material,
wherein the two types of active material layers are arranged in alternating layers within the cathode structure.

21. The cathode of claim 20, wherein the cathode further comprises a current collector, and wherein the active material layer closest to the current collector comprises a lithium ion intercalation active material.

22. The cathode of claim 20, wherein the cathode comprises between 3 and 12, between 3 and 6, between 4 and 8, or between 6 and 12 active material layers.

23. The cathode of claim 20, wherein the conversion active material comprises an electroactive sulfur composition.

24. The cathode of claim 23, wherein the electroactive sulfur composition is selected from: elemental sulfur, lithium sulfide, lithium polysulfide, polythionate, a sulfur-containing organic molecule, a sulfur-containing polymer, a sulfur-containing carbon composition, and a combination of any two or more of these.

25. The cathode of claim 20, wherein a discharge voltage range of the conversion active material and a discharge voltage range of the lithium ion intercalation active material substantially overlap.

26. The cathode of claim 20, wherein the lithium ion intercalation active material exhibits a higher average discharge voltage than the conversion active material.

27. The cathode of claim 20, wherein the lithium ion intercalation active material exhibits a lower average discharge voltage than the conversion active material.

28. The cathode of claim 20, wherein the conversion active material and the lithium ion intercalation active material both have discharge voltages in the range of 1.8 to 2.8 V.

29. The cathode of claim 20, wherein a total theoretical discharge capacity of the conversion active material is between 2 times and 5 times greater than the discharge capacity of the lithium ion intercalation active material.

30. The cathode of claim 20, wherein the lithium ion intercalation active material is selected from: metal oxides, metal sulfides, metal phosphates, metal selenides, and mixtures of any two or of these.

31. The cathode of claim 20, wherein the lithium ion intercalation active material comprises a metal sulfide.

32. The cathode of claim 31, wherein the metal sulfide is selected from vanadium sulfide, molybdenum sulfide, and titanium sulfide.

33. The cathode of claim 31, wherein the metal sulfide is selected from: VS₂, MoS₂, Mo₆S₈, and TiS₂.

34. The cathode of claim 31, wherein the metal sulfide comprises TiS₂.

35. The cathode of claim 20, wherein both the two types of active material layers are porous.

36. The cathode of claim 20, wherein the second type of active material layer has a lower porosity than the first type of active material layer.

37. The cathode of claim 20, wherein there is a porosity gradient in the first type of active material layer, and wherein the first type of active material layer has a lower porosity toward its interface with the second type of active material layer.

38. The cathode of claim 20, further comprising a conductive carbon coating between the current collector and the second type of active material layer.

39. The cathode of claim 21, wherein the current collector comprises a component selected from the group consisting of a metal foil, a metallized polymer film, and a carbon composition.

40. A lithium battery comprising a cathode of claim 1.

41.-42. (canceled)
